(19) United States
(12) Patent Application Publication
(10) Pub. No.: US 2013/0020853 A1
(43) Pub. Date: Jan. 24, 2013

(54) SECURE ME SYSTEMS

(71) Applicant: Oji Gibson, Liden, NJ (US)

(72) Inventor: Oji Gibson, Liden, NJ (US)

(21) Appl. No.: 13/554,383

(22) Filed: Jul. 20, 2012

Related U.S. Application Data
(60) Provisional application No. 61/510,718, filed on Jul. 22, 2011.

(51) Int. Cl. B60R 22/00; A47C 31/00

(52) U.S. Cl. 297/464

(57) ABSTRACT

A head restraint system for supporting a head of a user on a headrest including a headband having, an anterior side, and a posterior side; a first strap coupled to a left side posterior side of the headband, and a second strap coupled to a right posterior side of the headband; and at least one first fastener coupled to the first strap and at least one second fastener coupled to the second strap. The first strap on the headband is wrapped around a left side of the headrest while the second strap on the headband is wrapped around a right side of the headrest and then the female end and the male end of the first and second fasteners secure the first strap to the second strap around the headrest.

### CROSS-REFERENCE TO RELATED APPLICATION

The present application is related to and claims priority from prior provisional application Ser. No. 61/510,718, filed Jul. 22, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of restraints and more specifically relates to a head restraint system for use on a headrest to prevent a head of a user from moving involuntarily, thus promoting safety.

2. Description of the Related Art

In an automobile, a head seat restraint may be attached or integrated into the top of the seats in each seating position to limit the rearward movement of rear and adult occupant's head relative to their torso in a crash, so as to reduce the danger of whiplash or other injury to the cervical vertebrae. Head restraints must be at least 700 mm (27.6 in) above the seating reference point in their highest position and not deflect more than 100 mm (3.9 in) under a 372 N·m (3,292 in·lbf) moment. The lateral width of the head restraint, measured at a point either 65 mm (2.56 in) below the top of the head restraint or 635 mm (25.0 in) above the seating reference point must be not less than 254 mm (10.0 in) for use with bench seats and 171 mm (6.73 in) for use with individual seats. The head restraint must withstand an increasing rearward load until there is a failure of the seat or seat back, or until a load of 890 N (1,962 lb) is applied. Since their mandatory introduction in the late 1960s, head restraints have prevented or mitigated thousands of devastating injuries.

Children's heads may jostle around and jerk forward or sideways relative to a vehicle's headrest while their parents and caregivers drive over bumpy roads or different types of terrain since the children's heats are not restrained from movement. This can cause neck pain or possible injuries, especially if the children are not awake to correct their positioning. Parents and caregivers may frequently turn around to adjust their children's positioning, taking their attention away from the road. This can result in severe accidents. Adults and elderly passengers may also experience excessive, involuntary head-bobbing, which can cause pain, headaches, and nausea. An effective solution is necessary whereby a passenger's head is sufficiently restrained in a static positioning.

Various attempts have been made to solve the above-mentioned problems such as those found in U.S. Pat. Nos. 6,607,245; 4,707,031; 7,740,318; 7,832,802; 6,301,716; and 6,266,825. This prior art is representative of head restraining means. None of the above inventions and patents, taken either singly or in combination, is seen to describe the invention as claimed.

Ideally, a head restraint system should be user-friendly and safe in-use and, yet would operate reliably and be manufactured at a modest expense. Thus, a need exists for a reliable head restraint system for use in conjunction with a headrest to prevent a head of a user from moving involuntarily and to avoid the above-mentioned problems.

### BRIEF SUMMARY OF THE INVENTION

In view of the foregoing disadvantages inherent in the known retainer art, the present invention provides a novel head restraint system. The general purpose of the present invention, which will be described subsequently in greater detail is to provide a head restraint system for use on a headrest to prevent a head of a passenger user from moving involuntarily.

‘Secure Me’ of the present invention is designed to keep users' heads from unnecessarily bobbing and jerking while riding in vehicles. This innovative product preferably features a padded band designed to wrap around a vehicle passenger's head, comfortably securing it to the headrest of the vehicle seat. This product can be used by parents to keep their children's heads in place, particularly if their children are likely to fall asleep during car rides. Disabled children, adults, babies, and elderly vehicle passengers may also benefit from the use of this product.

A head restraint system for supporting a head of a user on a headrest is disclosed herein, in a preferred embodiment comprising: at least one headband having, an anterior side, and a posterior side; a first strap coupled to a left side posterior side of the headband, and a second strap coupled to a right posterior side of the headband; and at least one first fastener coupled to the first strap and at least one second fastener coupled to the second strap. The device is designed to be removably coupled to an existing vehicle seat head rest.

The first fastener comprises a female end located on the first strap while the second fastener comprises a male end located on the second strap. Further, the female end of the first fastener joins the first strap to the male end of the second fastener on the second strap around the head of the user to secure the head of the user adjacent to the headrest. The first strap on the headband is wrapped around a left side of the headrest while the second strap on the headband is wrapped around a right side of the headrest and then the female end and the male end of the first and second fasteners secure the first strap to the second strap around the headrest. The first strap and the second strap preferably comprise cloth. The first and second fasteners respectively comprise hook and loop fasteners in preferred embodiment; however other suitable fastening means may alternately be employed. The first fastener comprises at least one clip while the second fastener comprises at least one snap. The first strap and the second strap are adjustable.

The headband comprises elastic material sufficiently deformable to conform to the head of the user. The padding preferably comprises foam which is deformable to contour-fit the head of the user. The anterior side of the headband comprises padding to increase comfort of the user by reducing tension of the headband on the head of the user and to promote flexibility for ‘slight movement’. The headrest is located in a vehicle such as a car, bus, airplane or other land or non-land vehicle.

A method of use for a head restraint system comprises the steps of: sitting in a seat having a headrest; placing a headband about a head of a user; leaning the head backwards toward the headrest; grasping the first and the second straps; wrapping the first strap and the second strap around the headrest; securing the first strap to the second strap around the headrest via at least one fastener; and un-securing the first strap from the second strap so the head of the user is uncoupled from the headrest.

The present invention holds significant improvements and serves as a head restraint system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, head restraint system, constructed and operative according to the teachings of the present invention.

FIG. 1 shows a perspective view illustrating a head restraint system in an in-use condition according to an embodiment of the present invention.

FIG. 2 is a perspective view illustrating another in-use condition of the head restraint system according to an embodiment of the present invention of FIG. 1.

FIG. 3 is a front view illustrating the head restraint system using a hook and loop fastening means according to an embodiment of the present invention of FIG. 1.

FIG. 4 is a perspective view illustrating the head restraint system having a clip fastener according to an embodiment of the present invention of FIGS. 1 and 2.

FIG. 5 is a flowchart illustrating a method of use for the head restraint system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a retainer device and more particularly to a head restraint system for use on a headrest to prevent a head of a user from moving involuntarily and unsafely.

Generally speaking, Secure Me allows individuals to ride comfortably in vehicles without their heads involuntarily bobbing or jerking. The invention may comprise a thin, cloth strap approximately the size of a headband, designed to wrap around the front of the user's head and secure at the back preferably with hook and loop fasteners. The inside surface of the band can be lightly padded for comfort and reduced pressure while the invention is in use. Extending from the sides of the band may be two additional straps, designed to wrap around the headrest of the vehicle seat, and secure together at the back with hook and loop fasteners. The use of hook and loop fasteners may allow the sizes of the straps to be adjusted and customized to suit varying user needs.

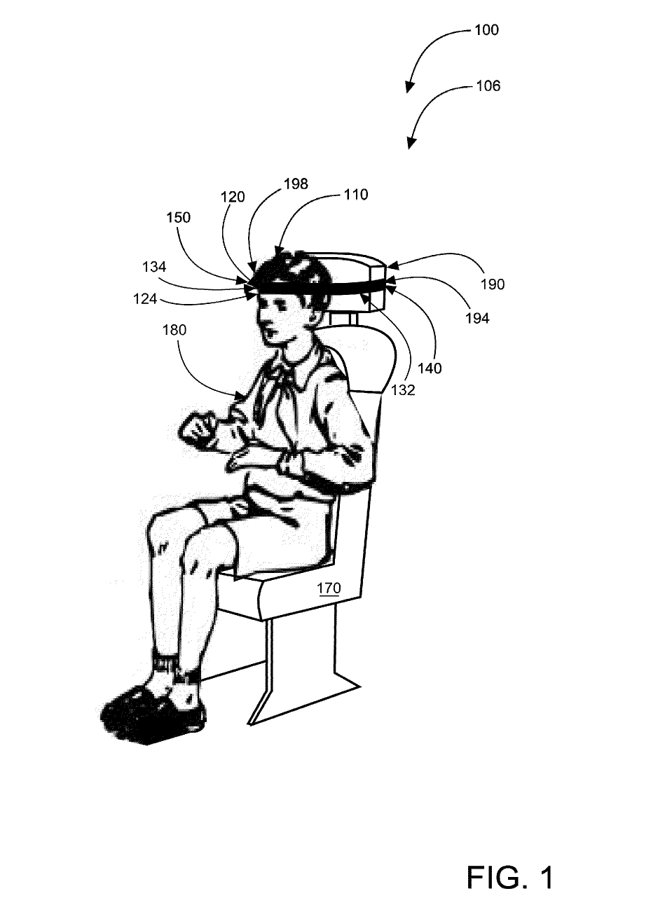

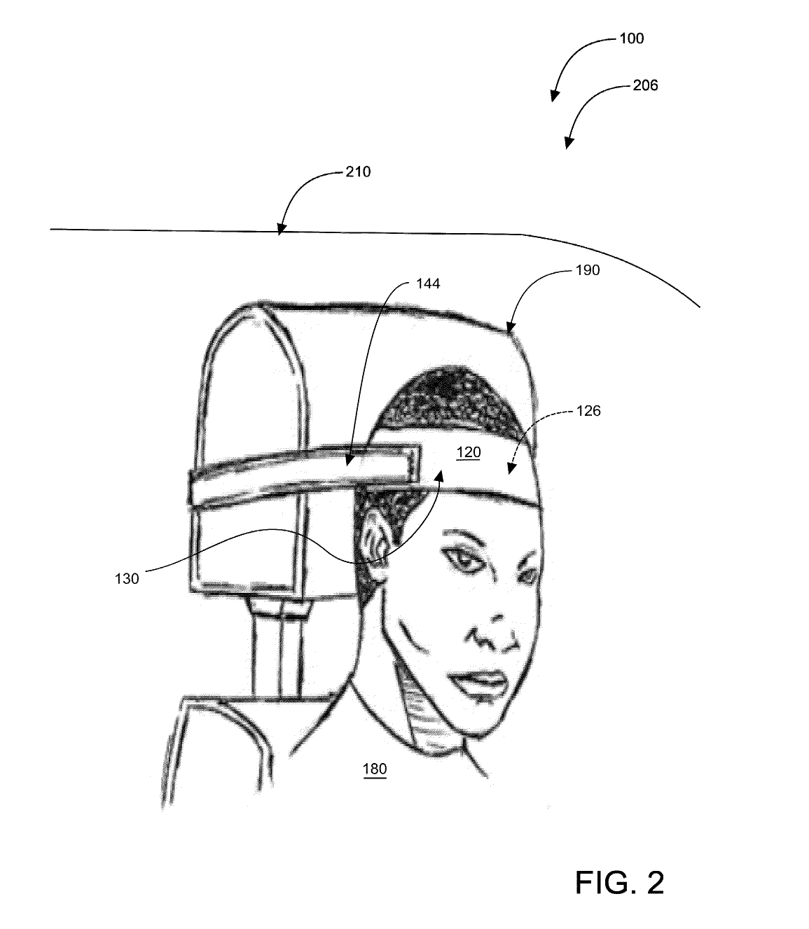

Referring to the drawings by numerals of reference there is shown in FIG. 1 and FIG. 2 showing perspective views illustrating head restraint system 100 for supporting head 110 of user 180 on headrest 190 in in-use condition 106 and in-use condition 206 according to an embodiment of the present invention.

Head restraint system 100 for supporting head 110 of user 180 on headrest 190 preferably comprises in a preferred embodiment at least one headband 120 having anterior side 124, and posterior side 130; first strap 140 coupled to left 132 posterior side 130 of headband 120, and second strap 150 coupled to right 134 posterior side 130 of headband 120, at least one first fastener 144 coupled to first strap 140 and at least one second fastener 154 coupled to second strap 150. Headband 120 first is coupled to head, then attached; in this way it is less likely to slip off.

Headrest 190 may be located on chair 170 as shown best in in-use condition 106 of FIG. 1. Further, headrest 190 may be located in vehicle 210 as shown best in in-use condition 206 of FIG. 2. Upon reading this specification, it should be appreciated that, under appropriate circumstances, considering such issues as user preferences, design preference, structural requirements, marketing preferences, cost, available materials, technological advances, etc., other headrest arrangements such as, for example, a motorized scooter, a wheelchair, etc., may be sufficient.

First strap 140 and second strap 150 may comprise cloth in a preferred embodiment. Upon reading this specification, it should be appreciated that, under appropriate circumstances, considering such issues as user preferences, design preference, structural requirements, marketing preferences, cost, available materials, technological advances, etc., other material arrangements such as, for example, nylon, fabric, cotton, etc., may be sufficient. Cloth is preferred such that it may absorb sweat and is comfortable against the skin of the user-passenger (user 180.)

First fastener 144 preferably comprises female end 148 located on first strap 140 while second fastener 154 comprises male end 158 located on second strap 150. Female end 148 of first fastener 144 may join first strap 140 to male end 158 of second fastener 154 on second strap 150 around head 110 of user 180 to secure head 110 of user 180 adjacent to headrest 190. First strap 140 on headband 120 is preferably wrapped around left side 194 of headrest 190 while second strap 150 on headband 120 is preferably wrapped around right side 198 of headrest 190 and then female end 148 and male end 158 of first fastener 144 and second fastener 154 secure first strap 140 to second strap 150 around headrest 190. In this way the present invention may be suitably secured from undesirable movement, such that it remains in stasis to headrest 190.

Headband 120 preferably comprises elastic material to conform to head 110 of user 180. Anterior side 124 of headband 120 comprises padding 126 (memory or other) to increase comfort of user 180 by reducing tension of headband 120 on head 110 of user 180. Padding 126 preferably comprises foam. The foam is deformable to contour-fit head 110 of user 180, similar to Memory Foam®. Upon reading this specification, it should be appreciated that, under appropriate circumstances, considering such issues as user preferences, design preference, structural requirements, marketing preferences, cost, available materials, technological advances, etc., other padding arrangements with deformable properties such as, for example, cotton, air inflated plastic; gel etc., may also be be sufficient.

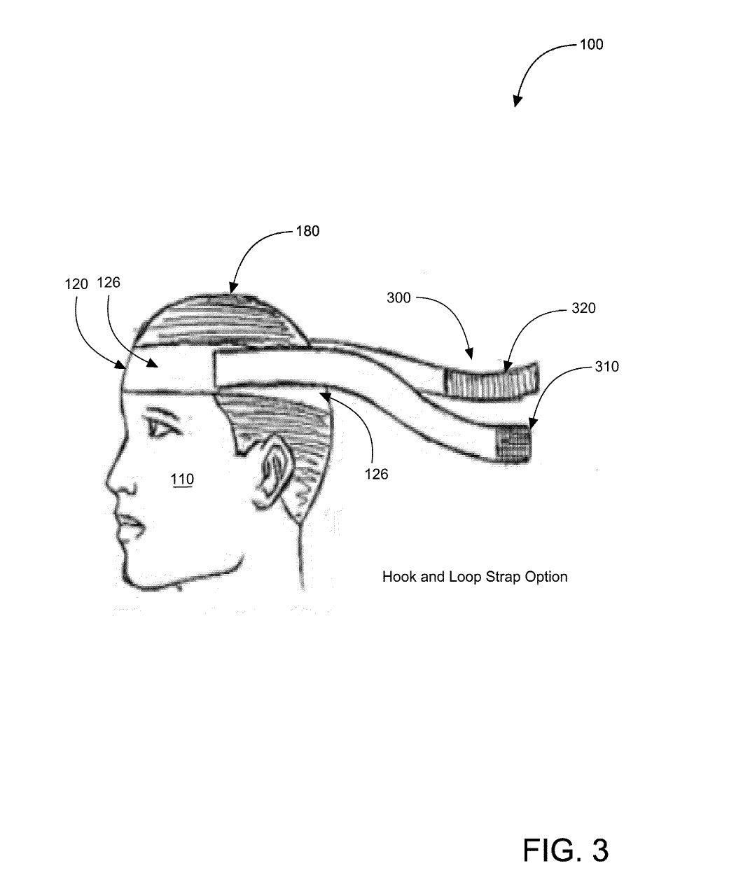

Referring now to FIG. 3 view illustrating head restraint system 100 having hook and loop fastener 300 according to an embodiment of the present invention of FIG. 1. First fastener 144 and second fastener 154 respectively comprise hook and loop fasteners. Hook-and-loop fasteners comprise two components: typically, two lineal fabric strips (or, alternatively, round “dots” or squares) which are attached (e.g., sewn, adhered, etc.) to the opposing surfaces to be fastened. The first component features tiny hooks 310; the second features even smaller and hairier loops 320. When the two components are pressed together, hooks 310 catch in loops 320 and the two pieces fasten or bind temporarily. When separated, by pulling or peeling the two surfaces apart, the Velcro® strips make a distinctive “ripping” sound. Hook and loop fastener 300 preferably permit first strap 140 and second strap 150 to be adjustable relative to one another and to headband 120. In this way desired tightness may be easily achieved.

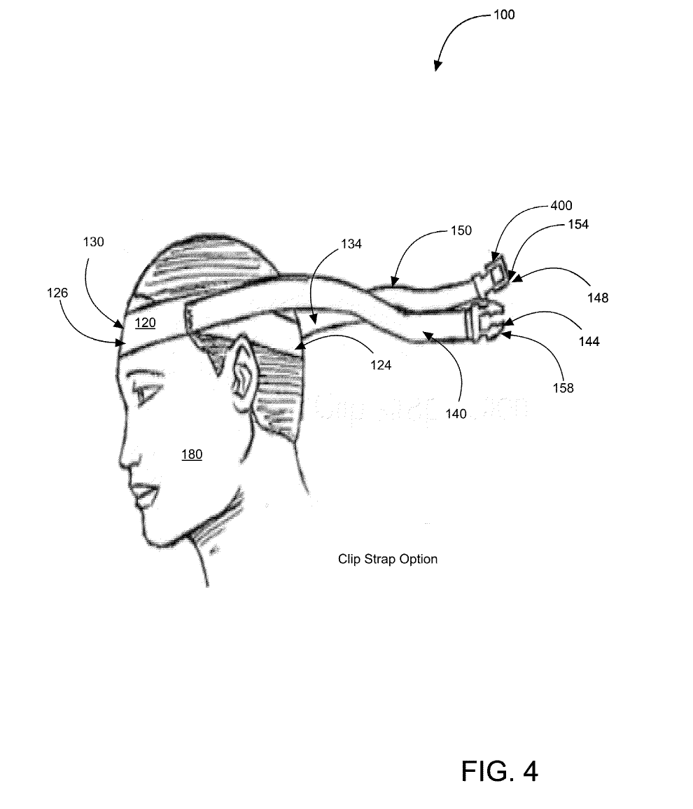

FIG. 4 is a perspective view illustrating head restraint system 100 having clip fastener 400 according to an embodiment of the present invention of FIGS. 1 and 2. First fastener 144 comprises at least one clip 400. Upon reading this specification, it should be appreciated that, under appropriate circumstances, considering such issues as user preferences, design preference, structural requirements, marketing preferences, cost, available materials, technological advances, etc., other fastener arrangements such as, for example, snaps, buttons, etc., may be sufficient.

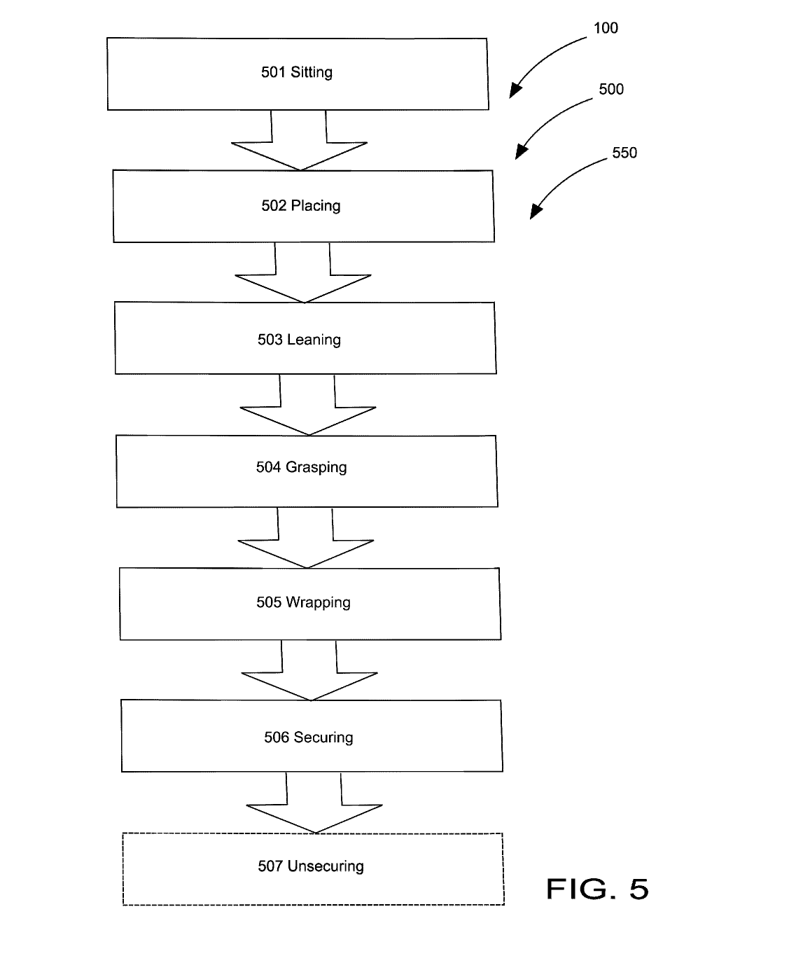

Referring now to FIG. 5, flowchart 550 illustrating method of use 500 for head restraint system 100 according to an embodiment of the present invention of FIGS. 1-4.

Method of use 500 for head restraint system 100 preferably comprises the steps of: step one 501 sitting in a seat having headrest 190; step two 502 placing headband 120 about head 110 of user 180; step three 503 leaning head 110 backwards toward headrest 190; step four 504 grasping first strap 140 and second strap 150; step five 505 wrapping first strap 140 and second strap 150 around headrest 190; step six 506 securing first strap 140 to second strap 150 around headrest 190 via at least one fastener 144, 154; and step seven 507 un-securing first strap 140 from second strap 150 so head 110 of user 180 is uncoupled from headrest 190.

It should be noted that step 507 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

what is claimed is new and desired to be protected by Letters Patent is set forth in the appended claims:

1. A head restraint system for supporting a head of a user on a headrest comprising:
at least one headband having,
an anterior side, and
a posterior side;
a first strap coupled to a left side posterior side of said headband, and
a second strap coupled to a right posterior side of said headband; and
at least one first fastener coupled to said first strap and at least one second fastener coupled to said second strap;
wherein said first fastener comprises a female end located on said first strap;
wherein said second fastener comprises a male end located on said second strap;
wherein said female end of said first fastener joins said first strap to said male end of said second fastener on said second strap around said head of said user to secure said head of said user adjacent to said headrest;
wherein said first strap on said headband is wrapped around a left side of said headrest while said second strap on said headband is wrapped around a right side of said headrest and then said female end and said male end of said first and second fasteners secure said first strap to said second strap around said headrest; and
wherein said anterior side of said headband comprises padding to increase comfort of said user by reducing tension of said headband on said head of said user.

2. The head restraint system of claim 1 wherein said first strap and said second strap comprise cloth.

3. The head restraint system of claim 2 wherein said headband comprises elastic material to conform to said head of said user.

4. The head restraint system of claim 2 wherein said first and second fasteners respectively comprise hook and loop fasteners.

5. The head restraint system of claim 2 wherein said first fastener comprises at least one clip.

6. The head restraint system of claim 2 wherein said second fastener comprises at least one snap.

7. The head restraint system of claim 2 wherein said first strap and said second strap are adjustable.

8. The head restraint system of claim 2 wherein said padding comprises foam.

9. The head restraint system of claim 8 wherein said foam is deformable to contour-fit said head of said user.

10. The head restraint system of claim 1 wherein said headrest is located in a vehicle.

11. The head restraint system of claim 1 wherein said headrest is located on a motorized scooter.

12. The head restraint system of claim 1 wherein said headrest is located on a wheelchair.

13. The head restraint system of claim 1 wherein said headrest is located on a chair.

14. A head restraint system for supporting a head of a user on a headrest comprising:
at least one headband having,
an anterior side, and
a posterior side;
a first strap coupled to a left side posterior side of said headband, and
a second strap coupled to a right posterior side of said headband; and
at least one first fastener coupled to said first strap and at least one second fastener coupled to said second strap;
wherein said first fastener comprises a female end located on said first strap;
wherein said second fastener comprises a male end located on said second strap;
wherein said female end of said first fastener joins said first strap to said male end of said second fastener on said second strap around said head of said user to secure said head of said user adjacent to said headrest;
wherein said first strap and said second strap comprises cloth;
wherein said first and second fasteners respectively comprise hook and loop fasteners;
wherein said first fastener comprises at least one clip;
wherein said second fastener comprises at least one snap;
wherein said first strap and said second strap are adjustable;
wherein said first strap on said headband is wrapped around a left side of said headrest while said second strap on said headband is wrapped around a right side of said headrest and then said female end and said male end of said first and second fasteners secure said first strap to said second strap around said headrest;
wherein said headband comprises elastic material to conform to said head of said user;
wherein said padding comprises foam;
wherein said foam has memory and is deformable to contour-fit said head of said user;
wherein said headrest is located in a vehicle; and
wherein said anterior side of said headband comprises padding to increase comfort of said user by reducing tension of said headband on said head of said user.

15. A method of use for head restraint system comprising the steps of:
sitting in a seat having a headrest;
placing a headband about a head of a user;
leaning said head backwards toward said headrest;
grasping said first and said second straps;
wrapping said first strap and said second strap around said headrest; and
securing said first strap to said second strap around said headrest via at least one fastener.

16. The method of claim 15 further comprising the step of un-securing said first strap from said second strap so said head of said user is uncoupled from said headrest.
